(19) United States
(12) Patent Application Publication
(10) Pub. No.: US 2019/0150543 A1
(43) Pub. Date: May 23, 2019

(54) METHOD FOR RAPID CREATION OF CAD PATTERNS FOR APPAREL, ACCESSORIES & FOOTWEAR

(71) Applicant: Balamurugan Selvarajan, Bangalore (IN)

(72) Inventor: Balamurugan Selvarajan, Bangalore (IN)

(21) Appl. No.: 15/819,267

(22) Filed: Nov. 21, 2017

(51) Int. Cl. A41H 3/00; G06F 17/50; A43D 8/12

(52) U.S. Cl. CPC A41H 3/007; G06F 17/50; A43D 2200/60; G06F 2217/02; G06F 2217/12; A43D 8/12

(57) ABSTRACT

A method for rapid creation of CAD patterns for apparel, accessories and footwear is presented. The invention outlines a novel method comprising Encapsulation, Intersection, Abstraction and Coupling to rapidly create and edit CAD patterns, significantly reducing the time and effort required to create or modify CAD patterns. Further, a method for attaching attributes to points on a path of pattern elements and then using this to automatically grade, transform the patterns for different geographies or fix errors is also presented.

### BACKGROUND

### Technical Field

The present invention is related to pattern making. More specifically, this invention relates to creation of CAD patterns for apparel, accessory and footwear. In particular, this invention outlines a novel way to significantly reduce the time and effort required to create or modify CAD patterns for apparel, accessory and footwear.

### Description of Related Art

Pattern Making for apparel, accessories and footwear has been in existence for a very long time. Computer Aided Design (CAD) and pattern making software have also been in use for decades.

Traditionally, the pattern maker would create the patterns on a piece of cardboard and use that to shape and cut the fabric for making apparel, accessories or footwear. With the advent of computers, this process has largely become digitized.

Most of the present tools for Pattern Making require the user to think and operate using basic geometric building blocks such as lines, curves, rectangles, etc. Even where a higher level of abstraction such as an entire Front or Sleeve is provided, information mapping a geometry to physical attributes and to each other are missing, consequently requiring a user to manually edit the paths at every point. It is also time consuming to manually grade each size or manually change a pattern for different genders, geography, ethnicity or age.

The above-mentioned shortcomings, disadvantages, and problems are addressed herein and which will be understood by reading and studying the following specification.

### SUMMARY OF THE EMBODIMENTS HEREIN

The various embodiments herein provide a method for rapidly creating CAD patterns for apparel, accessory and footwear using a novel method comprising the steps: Encapsulation, Intersection, Abstraction and Coupling.

Encapsulation provides preset pattern elements (Encapsulated Components) as basic building blocks. The complexity and number of such Components required for completeness is vast. However, the overwhelming number of variations can be significantly reduced by grouping them according to anatomical similarities or usage variations.

For example, in apparel CAD, the Encapsulated Components required can be simplified by considering just the extensions of the human anatomy from the torso, namely neck, arm and leg. In one embodiment of this invention for apparel, patterns elements for neck, arm hole and leg alone are sufficient as Encapsulated Components. In another embodiment herein, the Encapsulated Components are augmented with additional pattern elements for Chest, Waist, Hip, Thigh, Bicep, Elbow, Wrist, Knee, Ankle and Head.

Encapsulated Components can further include specialized sub-components. Since the human arm is attached a little more to the front than to the back of the torso, the armhole for the front is deeper than the armhole for the back. Thus, providing specialized variants for Encapsulated Components further simplifies the pattern creation process.

The operation of Intersection enables two different paths to be intersected and a new path created. In one embodiment of this invention, basic geometries such as line, arc, circle, rectangle, path or an Encapsulated Components can be intersected with each other to create Composite Components. Composite Components themselves can be further intersected with other Components to create more complex Composite Components.

The operation of Intersection is further comprised of geometric Union, Addition, Subtraction and can be further augmented with a plurality of operations such as: Cut, Join, Offset, Mirror, Mirror with duplicate paths removed, Flip, Rotate, Seam—Outer, Seam—Inner and Seam with variable offset.

When intersecting two paths, there will be up to four different combination of intersected paths that can be derived. In one embodiment of this art, the shortest, closed path is automatically chosen. In another embodiment, the user is prompted to select one from a list of options.

All CAD tools capture points and path as a geometry. The novel concept of Abstraction outlined in this invention, adds “intelligence” by assigning a Defining Attribute to one or more points and paths. For example, by augmenting two points (x,y) and (x′, y′), with additional information that they represent shoulder points on a Male, Chest 36 inches, height 72 inches, the pattern elements can then be automatically adjusted or graded, not only at that point, but also at all other connected points. As can be seen, Defining Attributes not only provide information about a particular point or path, but can be used to derive additional information about nearby points and connected paths.

Coupling allows for certain geometries to be linked to each other. For example, in an apparel, the front armhole (601) and back armhole (603) correspond to the sleeve cap (602) and the path lengths must be in proportion: 602=601+603. The novel concept of Coupling outlined in this invention, allows for capturing and automatically adjusting one when the other changes.

The Defining Attributes and Encapsulation can be augmented and extended for each domain (Apparel, Footwear, Furnishing, Metal Casting, etc). For example, the Encapsulated Components is augmented with pattern elements for Strap, Pouch and Liner for accessories; and Tongue, Vamp, Heel and Toecap for footwear; and Abstraction is augmented with a plurality of Defining Attributes chosen from that domain such as Toe point, Heel point, Width and Feet length for footwear and Buckle point, Strap point and Base width for accessory.

In one embodiment of this invention, the chest point and height are captured as Defining Attributes for an apparel, thereby enabling grading of the pattern for an entire set of sizes from a size chart automatically. In another embodiment, the heel point and toe point are captured to enable grading of footwear patterns.

Abstraction is a powerful tool by itself However, in one embodiment of this invention, the step of Abstraction is preceded by the step of user selection of a body size, which is then used along with a standard body measurement chart to guide the user during the creation of the patterns, thereby speeding up the process and avoiding measurement errors.

The various embodiments above, provide a system and method for rapidly creating CAD patterns for apparel, accessory and footwear. The same techniques are used to automatically grade the patterns for different sizes and to assist or automatically modify the patterns to different specifications. These same techniques can be easily extended to other domains such as accessories, footwear, furnishings, metal castings, gear cutting and any other domain that requires creation of CAD patterns for subsequent use in manufacturing, both manual and CAM.

This and other aspects of the embodiments herein will be better appreciated and understood when considered in conjunction with the following description and the accompanying drawings. Although the embodiments herein refer mostly to apparel, they are given by way of an illustration and not of a limitation. Similarly, it should be understood, that the descriptions and drawings, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The objects, features, and advantages will be apparent to those skilled in the art from the following description of the preferred embodiment and the accompanying drawings in which:

FIG. 1 illustrates a block diagram of a system for creating CAD patterns according to one embodiment herein.

FIG. 2 illustrates Encapsulation, according to one embodiment of this invention for an exemplary apparel.

FIG. 3 illustrates specialized variants of Encapsulation, for one pattern element illustrated in FIG. 2.

FIG. 4 illustrates the operation of Intersection, according to one embodiment of this invention.

FIG. 5 illustrates Abstraction, according to one embodiment of this invention.

FIG. 6 illustrates Coupling, according to one embodiment of this invention.

FIG. 7 illustrates a typical grading process.

FIG. 8 illustrates grading using Defining Attributes and size chart, according to one embodiment of this invention.

Although the specific features of the embodiments herein are shown in some drawings and not in others, this is done for convenience only as each feature may be combined with any or all of the other features in accordance with the embodiments herein.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for rapidly creating CAD patterns for apparel, accessory and footwear using a novel method comprising the steps: Encapsulation, Intersection, Abstraction and Coupling.

Encapsulation provides preset pattern elements (Encapsulated Components) as basic building blocks. The complexity and number of such Components required for completeness is vast. However, the overwhelming number of variations can be significantly reduced by grouping them according to anatomical similarities or usage variations.

For example, in apparel CAD, the number of Encapsulated Components required can be significantly reduced by considering just the extensions to the human anatomy from the torso, namely neck, arm and leg. In one embodiment of this invention for apparel, patterns elements for neck, arm hole (Scye) and leg hole (Stride) are sufficient as Encapsulated Components. In another embodiment herein, the Encapsulated Components are augmented with additional pattern elements for Wrist line, Ankle line, Chest, Waist, Hip, Thigh, Bicep, Elbow, Knee and Head. Encapsulated Components can further include specialized sub-components.

The operation of Intersection enables two different paths to be intersected and a new path created. In one embodiment of this invention, basic geometries such as line, arc, circle, rectangle, path or an Encapsulated Components can be intersected with each other to create Composite Components. Composite Components themselves can be further intersected with other Components to create more complex Composite Components. The operation of Intersection is further comprised of geometric Union, Addition and Subtraction.

All CAD tools capture points and path as a geometry. The novel concept of Abstraction outlined in this invention, adds “intelligence” by assigning a Defining Attribute for one or more points and paths on a pattern element or Component. For example, by augmenting two points (x,y) and (x′, y′), with additional information that they represent shoulder points on a Male, Chest 36 inches, height 72 inches, the pattern elements can then be automatically adjusted or graded, not only at that point, but also at all other connected points. As can be seen, Defining Attributes not only provide information about a particular point or path, but can be used to derive additional information about nearby points and connected paths.

Coupling allows for certain geometries to be linked to each other. For example, in an apparel, the front armhole (FIG. 6, 601) and back armhole (FIG. 6, 603) correspond to the sleeve cap (FIG. 6, 602) and the path lengths must be in proportion: 602=601+603. The novel concept of Coupling outlined in this invention, allows for capturing and automatically adjusting the length and shape of one when the length or shape of the other changes.

This and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

FIG. 1 illustrates a block diagram of an exemplary system for creating CAD patterns according to one embodiment herein. The Computing Device (102) is a computer, tablet, smartphone or similar electronic device with a memory, processor and display and may optionally include a local storage or database. The user (101) interacts with the system via a user interface. The application can be a desktop, web based or run on a client connected to a server over a communication network. The user interface can be accessed through a traditional GUI or Web Browser.

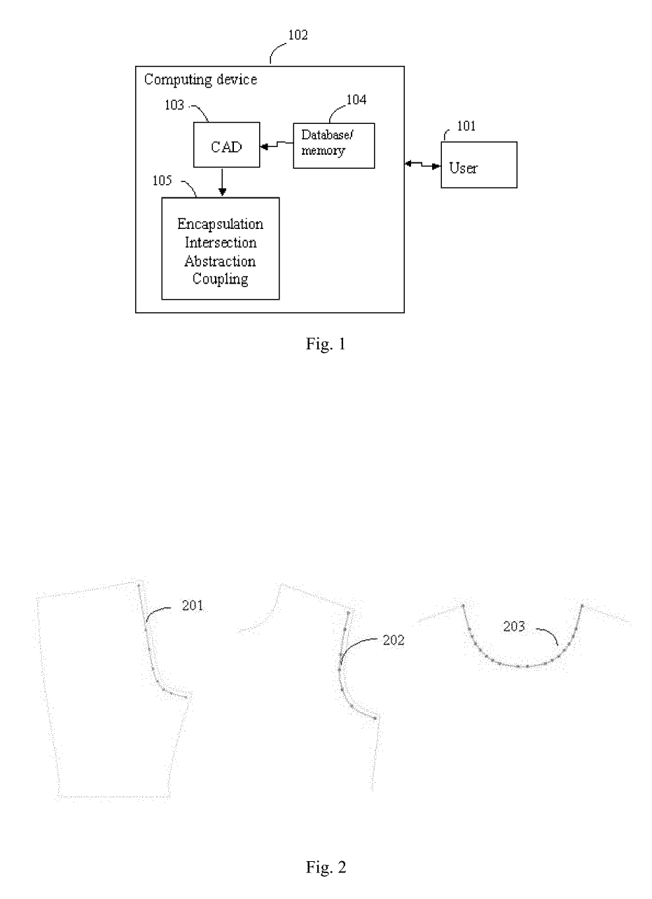

FIG. 2 illustrates Encapsulation, according to one embodiment of this invention for apparel. The exemplary apparel in FIG. 2 includes patterns elements for neck (203), arm hole or Scye (202) and leg hole or Stride (201). Encapsulated Components can further include specialized sub-components.

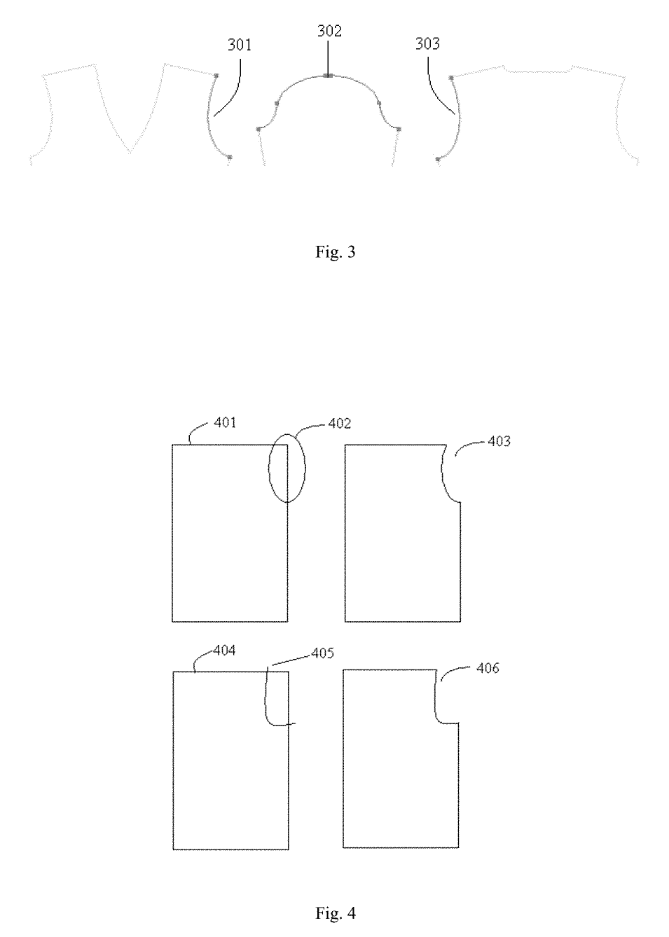

FIG. 3 illustrates specialized variants of Encapsulation for the pattern element (202) illustrated in FIG. 2. Since the human arm is attached a little more to the front than to the back of the torso, the armhole for the front is deeper than the armhole for the back. Thus, providing specialized variants for Encapsulated Components speeds up the pattern creation process.

As can be seen in FIG. 3, the Encapsulated Component Arm hole (202) includes specialized variants such as Front Arm hole (301), Back Arm home (303) and Sleeve Cap (302). Since the Sleeve Cap is stitched to the Front and Back Arm home, it is, but a variation of the same pattern element. In fact, its curvature and path length should complement and be in proportion to the Front & Back arm home pattern.

FIG. 4 illustrates the operation of Intersection, according to one embodiment herein. Each pattern element or Component is comprised of points, rectangles, lines, curves and other geometric paths and can either be open or closed. The operation of Intersection enables two different paths (401 & 402) to be intersected to create a new path (403). 403 is created by Subtracting 402 from 401. Similarly, an open path (405) is intersected with (404) to create (406). In one embodiment of this invention, basic geometries such as line, arc, circle, rectangle, path or an Encapsulated Components are intersected with each other to create Composite Components. Composite Components themselves can be further intersected with other Components to create more complex Composite Components.

When intersecting two paths, there can be up to four different combination of intersected paths that can be derived (Inner-Inner, Inner-Outer, Outer-Inner, Outer-Outer). In one embodiment of this art, the shortest, closed path is automatically chosen. In another embodiment, the user is prompted to select one from a list of options.

The operation of Intersection is further comprised of geometric Union, Addition and Subtraction and is typically augmented with a plurality of operations such as: Cut, Join, Offset, Mirror, Mirror with duplicate paths removed, Flip, Rotate, Seam—Outer, Seam—Inner and Seam with variable offset.

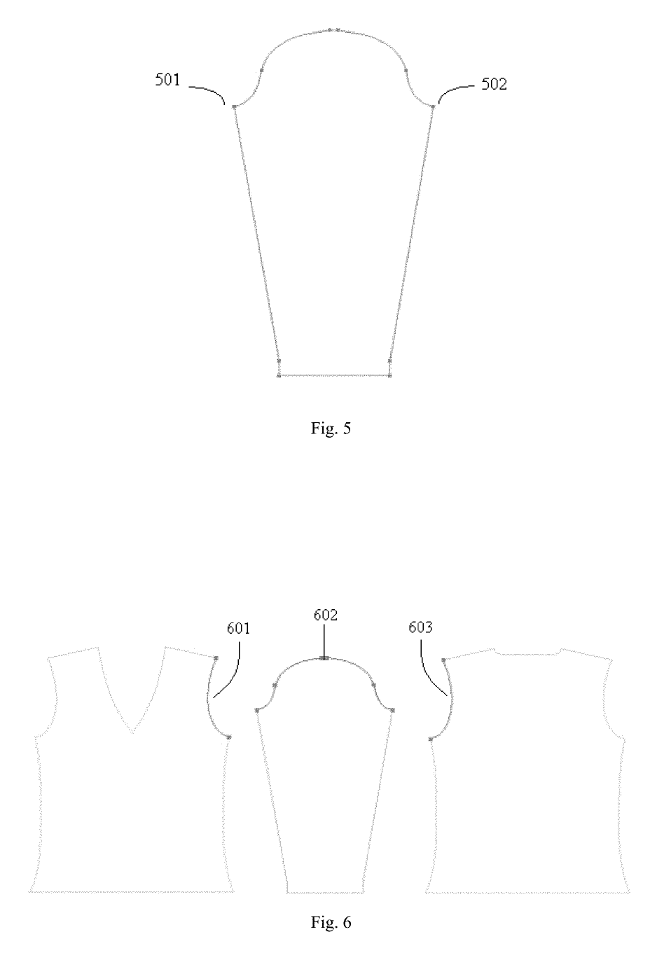

FIG. 5 illustrates Abstraction, according to one embodiment of this invention. Consider the two points 501 & 502 in the FIG. 5. All CAD tools capture points and path as a geometry. The novel concept of Abstraction outlined in this invention, adds “intelligence” by assigning a Defining Attribute to one ore more of these points. For example, by adding Defining Attributes to 501 (x,y) and 502 (x′, y′), that they represent the shoulder point on a Male, Chest 36 inches, height 72 inches, the pattern elements can subsequently be adjusted or graded automatically.

There are a multitude of ways to represent Defining Attributes. According to one embodiment of this invention, an exemplary path geometry with Defining Attributes is illustrated below. The Defining Attribute for body “M,36,72” (Gender,Chest,Height) is common to all elements, while path level attributes such as “DA=1,4:SP” (Defining Attribute=points 1 & 4 are Shoulder Point) are element specific.

<pattern DA=”M,36,72”>
<path d=″M1631.809,1653.7c23.424-112.453,150.41-180.314,334.135-196.343″/>

| | |
|---|---|
| <path | d=″M2337.461,1653.7c-23.422-112.453-150.408-180.314-334.132-196.343″ |

DA=”1,4:SP”/>
<line x1=″1498.37″ y1=″1829.357″ x2=″1717.331″ y2=″3065.238″/>
<line x1=″2470.371″ y1-″1829.357″ x2=″2257.33″ y2-″3065.238″/>
<path d=″M1631.809,1653.7c-11.025,104.781-59.487,161.048-132.4,175.657″/>

| | |
|---|---|
| <path | d=″M2337.461,1653.7c11.025,104.781,59.488,161.048,132.402,175.657″ |

DA=”1,4:SP”/>
<line y1=″3137.238″ x2=″2257.33″ y2=″3137.238″/>
<line x1=″1717.331″ y1=″3065.238″ x2=″1717.331″ y2=″3137.238″/>
<line x1=″2257.33″ y1=″3065.238″ x2=″2257.33″ y2=″3137.238″/>
</pattern>

In one embodiment of this invention for apparel, the Defining Attributes are chosen from a list consisting of Neck point, Shoulder point, Chest point, Waist point, Hip point, Thigh point, Bicep point, Elbow point, Wrist point, Knee point, Ankle point, Head Point and Body Height.

The Defining Attributes and Encapsulation should be replaced and extended for each domain (Apparel, Footwear, Furnishing, Metal Casting, etc). For example, replacing the Encapsulated Components with pattern elements for Strap, Pouch and Liner for accessories and Tongue, Vamp, Heel and Toecap for footwear; and replacing the Abstraction with a plurality of Defining Attributes chosen from that domain such as Toe point, Heel point, Width and Feet length for footwear and Buckle point, Strap point and Base width for accessory.

Abstraction is a powerful tool by itself. However, in one embodiment of this invention, the step of Abstraction is preceded by the step of user selection of a body size, which is then used along with a standard body measurement chart to “guide” the user during the creation of the patterns, thereby enabling faster creation of Components and avoiding measurement errors. The process of guiding uses well known methods of user interface such as snap-to-point, auto-align, click-to-join, etc.

FIG. 6 illustrates Coupling, according to one embodiment of this invention. Coupling allows for certain geometries to be linked to each other. Since the Sleeve Cap is stitched to the Front and Back Arm hole, its curvature and path length should complement and be in proportion to the Front & Back arm hole pattern. As shown in FIG. 6 of an exemplary apparel, the front armhole (601) and back armhole (603) correspond to the sleeve cap (602) and the path lengths must be in proportion: 602=601+603.

The novel concept of Coupling outlined in this invention, enables the capturing of this information and automatically adjusting the length and shape of one (e.g: 602) when the length or shape of the other changes (e.g: 601 or 603).

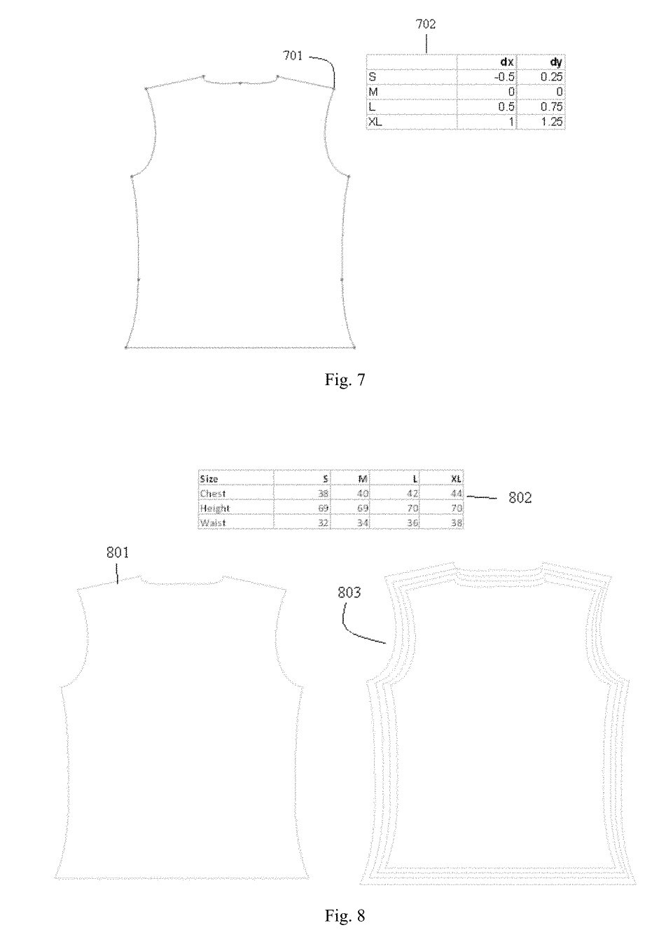

FIG. 7 illustrates a typical grading process. As can be seen, a (dx, dy) is specified for each point (x,y) to create a new point (x′, y1′)=(x+dx, y+dy). This is a rather cumbersome process requiring a significant amount of time. According to one embodiment of this invention, the chest point and height are captured as Defining Attributes, thereby enabling grading of the pattern for an entire set of sizes in a size chart automatically.

FIG. 8 illustrates grading using Defining Attributes and size chart, according to one embodiment of this invention. When the points have Defining Attributes such as Shoulder Point, Chest Point and Waist Point, the Defining Attributes are used in conjunction with a size chart to automatically create a new set of paths, whose points vary from the original in exact proportion to the variation in size chart of the corresponding Defining Attribute, thereby automatically creating graded pattern elements for each Component, without user intervention.

As can be seen clearly, using Defining Attributes for grading is fast and intuitive (applying (dx, dy) to each point manually versus using size chart for all points automatically), significantly reducing time, effort and measurement errors. In yet another embodiment of this invention, a similar technique using the heel point and toe point are used to enable grading of footwear patterns.

Defining Attributes also serve another useful purpose, in automatically modifying a pattern for a different size, gender, age, body type or geography. In one embodiment of this invention, a pattern made for Size M for US (40″ bust) is automatically converted to Size M for Asia (36″ Bust) using Defining Attributes for Chest, Height and a size chart. Similarly, if the user made an error and created patterns for size 40″, instead of 36″, all the pattern elements for all components could be automatically fixed by simply changing one measurement.

In yet another embodiment of this invention, the Defining Attributes of Abstraction are used to automatically adjust the pattern elements of each Component based on a plurality of user selection chosen from a list of gender, size, ethnicity, age, body type and geography.

The techniques of Encapsulation, Intersection, Abstraction and Coupling not only apply to creation of CAD patterns, but apply equally effectively to editing an existing CAD patterns. In fact, CAD patterns created using a traditional Pattern Maker can be imported using standard file format like DXF into a Pattern Maker incorporating the teachings of this invention, adding Defining Attributes during import and subsequently taking advantage of the speed, ease, automation and error correction capabilities bestowed by this invention.

The various embodiments above, provide a system and method for rapidly creating and modifying CAD patterns for apparel, accessory and footwear. The same techniques are used to automatically grade the patterns for different sizes and to assist or automatically modify the patterns to different specifications. These techniques apply equally to all domains that requires creation of CAD patterns for designing or manufacturing (manual and CAM).

Although the embodiments herein refer mostly to apparel, they are given by way of an illustration and not of a limitation. Many changes and modifications may be made within the scope of the embodiments for accessories, footwear, metal casting, furnishings, gear cutting and other domains, without departing from the spirit hereof. Although the specific features of the embodiments herein are shown in some and not in others, this is done for convenience only as each feature may be combined with any or all of the other features in accordance with the embodiments herein.

The foregoing description of the specific embodiments will so fully reveal the general nature of the embodiments herein that others can, by applying current knowledge, readily modify and/or adapt for various other applications, as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

I claim:

1. A computer implemented method for rapid creation of patterns for apparel, accessory and footwear, the method comprising:
Encapsulation: wherein, a preset pattern element is provided for at least each of the anatomical extensions from the human torso, namely Neck, Arm hole (Scye) and Leg hole (Stride), comprising the Encapsulated Components.
Intersection: wherein, a plurality of basic geometry such as rectangle, circle, path, arc and line are intersected with each other and the Encapsulated Components to create Composite Components.
Abstraction: wherein, each Component includes a Defining Attribute for at least one of its points, the attributes chosen from a list consisting of Neck point, Shoulder point, Chest point, Waist point, Hip point, Thigh point, Bicep point, Elbow point, Wrist point, Knee point, Ankle point, Head Point and Body Height.
Coupling: wherein, one or more Components are linked together, such that changes to the length or shape of one, automatically changes the corresponding shape or length of the other.

2. The method of claim 1, wherein each of the Component is further comprised of points, paths, lines and curves and can either be open or closed.

3. The method of claim 1, wherein, a created Composite Component is thereafter used as an Encapsulated Component for further operation.

4. The method as claimed in claim 1, wherein an Encapsulated Component such as the Arm hole, further comprises of specialized variants such as Front Arm hole, Back Arm hole and Sleeve Cap.

5. The method as claimed in claim 1, where the Defining Attributes of Abstraction on a pattern element are used in conjunction with a size chart for a particular geography to automatically create a new set of paths, whose points vary from the original in exact proportion to the variation in size chart of the corresponding Defining Attribute, thereby automatically creating graded pattern elements for each Component.

6. The method as claimed in claim 1, wherein the step of Abstraction is preceded by the step of user selection of a body size, which is then used to guide the creation of Components and Defining Attributes using user interface methods such as snap-to-point and auto-align.

7. The method as claimed in claim 1 and claim 5, wherein the Defining Attributes of Abstraction are used to automatically adjust the pattern elements of each Component based on a plurality of user selection chosen from a list of gender, size, ethnicity, age, body type and geography.

8. The method of claim 1, wherein the operation of Intersection is further comprised of the geometric operators Union, Intersection, Addition and Subtraction.

9. The method of claim 1, wherein the operation of Intersection is further augmented by operations such as Cut, Join, Offset, Mirror, Mirror with duplicate paths removed, Flip, Rotate, Seam—Outer, Seam—Inner and Seam with variable offset.

10. The method of claim 1, wherein the method is applied to accessory and footwear, by replacing the Encapsulated Components with pattern elements corresponding to that domain, such as Strap, Pouch and Liner for accessories and Tongue, Vamp, Heel and Toecap for footwear; and replacing the Abstraction with a plurality of Defining Attributes chosen from that domain such as Toe point, Heel point, Width and Feet length for footwear and Buckle point, Strap point and Base width for accessory.
